(19) United States
(12) Patent Application Publication
(10) Pub. No.: US 2026/0246273 A1
(43) Pub. Date: Aug. 20, 2026

(54) POWER CONTROL SYSTEMS FOR BATTERY ENERGY STORAGE SYSTEMS USING SECOND-LIFE ELECTRIC VEHICLE (EV) BATTERIES

(71) Applicants: San Diego State University Research Foundation, San Diego, CA (US); The Regents of the University of California, Oakland, CA (US)

(72) Inventors: Shuofeng Zhao, La Mesa, CA (US); Chunting Chris Mi, San Diego, CA (US); Wen-Chin Liu, San Diego, CA (US)

(21) Appl. No.: 18/872,236

(22) PCT Filed: Jun. 6, 2023
(86) PCT No.: PCT/US2023/024549

§ 371 Date: Dec. 5, 2024

Related U.S. Application Data
(60) Provisional application No. 63/366,056, filed on Jun. 8, 2022.

(51) Int. Cl. H02J 3/32; B60L 58/12; B60L 58/22; H01M 10/42; H02M 1/00; H02M 3/00; H02M 3/335

(52) U.S. Cl. CPC H02J 3/32; B60L 58/12; B60L 58/22; H01M 10/425; H02M 1/0058; H02M 1/008; H02M 3/01; H02M 3/33573; H02M 3/33576; B60L 2210/10; B60L 2210/30; H01M 2010/4271; H01M 2220/20

(57) ABSTRACT

Power control systems for battery energy storage systems using second-life electric vehicle (EV) batteries are disclosed. In one aspect, the power control system includes a hardware architecture including an AC/DC converter in which an AC side of the AC/DC converter is connected to an electrical grid via a first terminal and a DC side of the AC/DC converter is connected to a DC bus and a plurality of DC/DC converters. A primary side of each of the DC/DC converters is connected to the DC bus and a second side of each of the DC/DC converters is connected to one of the EV batteries via a corresponding battery terminal. The power control system further includes a controller configured to coordinate the AC/DC converter and the DC/DC converters to maintain power equilibrium and to realize independent power control of each of the batteries and the grid-tied interface.

### CROSS-REFERENCE TO RELATED APPLICATION(S)

This application claims the benefit of U.S. Provisional Application No. 63/366,056, filed Jun. 8, 2022. The foregoing application is hereby incorporated by reference in its entirety.

### STATEMENT REGARDING STATE OF CALIFORNIA SPONSORED R&D

This invention was made with State of California support under California Energy Commission grant number EPC-19-053. The Energy Commission may have certain rights to this invention.

### BACKGROUND

### Field

Embodiments of this disclosure relate to power control systems (PCSs), and more particular, to the use of second-life (SL) electric vehicle (EV) batteries in PCSs.

### Description of the Related Art

Power generation utilizing renewable energy sources has been playing an ever-increasing role globally both to meet the growing demand and to mitigate the climate change caused by carbon emission. The most popular renewable energy sources such as solar energy and wind energy suffer from intrinsic unpredictability and fluctuation, resulting in the same weaknesses in their respective power generation. Adding a battery energy storage system (BESS) to these systems greatly improves the overall output quality and brings benefits to both users and the utility grid. To realize these capabilities, the BESS should be grid-tied and capable of deliver or absorb power on user demand.

With the advancement in lithium technologies and the resulting decreased costs, the popularity of BESS is in a continuous climb. One particular prospect is using SL EV battery packs as the storage units in BESSs. EVs to date already have a major share in the market and keep gaining momentum. A massive quantity of end-of-serviceable-life (EOL) batteries are projected to come out in the coming few years and thereafter. These retired EV batteries still have considerable capacities which qualify them to a SL usage in less demanding applications such as in stationary BESSs. This SL usage of EV batteries will generate considerable benefits regarding reducing material costs and environmental impact. Because the EOL EV batteries will have various capacities and state-of-health (SOH) depending on the make, model, and specific conditions of their respective EVs, a BESS using multiple such batteries should have the capability of individually controlling the power of each EV battery pack so that the aging of these batteries is delayed, and the overall cost reduced as a result.

Independent on-demand power control on both the grid-tied end and the battery end is challenging because it can be desirable to continuously maintain the power equilibrium and provide a high dynamic range to accommodate fluctuations in demand.

A BESS system with multiple storage units is featured in a number of designs. Relatively simple designs with direct parallel connection of battery modules can be found in patents such as U.S. Pat. No. 8,907,522 B2. Typically, a single DC/DC converter is used as the interface between all battery modules to the DC bus, therefore the independent control of each battery module is difficult to realize. Designs with each battery module connecting to the DC bus via its respective DC/DC converter provide more flexibility in battery control, but still with various constraints in the control freedom. In U.S. Pat. No. 6,043,629 A, multiple battery-converter units are coordinated by a central charge/discharge controller. The central controller relies on the real-time voltage sensing to regulate the DC bus voltage by actively distributing the load among all battery-converter units. The voltage feedback control requires high response speed and is difficult to achieve using ordinary inter-system communication protocols, resulting in the design overall atomic and difficult to scale by the user. In U.S. Pat. No. 8,245,801 B2, KR 10-1482300 B1, and US 2017/0358935 A1, multiple battery-converter units are also featured for electrified vehicle power system. In these designs, multiple battery-converter units can be independently controlled, but the bus voltage regulating relies on a higher priority storage-converter-controller module, meaning the units in these systems are not equal in importance.

A BESS with multiple storage units which are truly equal, easy to scale, supporting independent power control to all battery and AC terminals will provide great benefit in high-power and high-capacity SL EV BESS application but yet to be designed.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

Aspects of this disclosure address the above-description problems by providing a PCS designed for BESSs which use SL EV batteries as energy storage units. The PCS includes a specific hardware architecture (or a specific group of similar architectures) and a corresponding control strategy.

In some embodiments, the hardware architecture includes a single AC/DC converter and multiple independent DC/DC converters. The AC terminal of the AC/DC converter can be connected to the utility grid, the secondary side DC terminals of the DC/DC converters can be connected to their respective SL EV battery packs, and the DC terminal of the AC/DC converter and the primary side DC terminals of the DC/DC converters can be interconnected via a common DC bus. The connections from the secondary side DC terminals of the DC/DC converters to the batteries may differ.

In some embodiments, each independent DC/DC converter is connected to its own and only battery.

In some embodiments, each two or more independent DC/DC converters are connected to one respective battery.

In some embodiments, each independent DC/DC converter is only connected to one battery.

In some embodiments, the control strategy includes several distinct functionalities such as normal operation control, exception and fault handling, data logging, etc. Three functionalities of the control strategy include: starting-up control, voltage droop channel rotation scheme, and SOC balancing scheme. The starting-up control can send out a specific sequence of commands to each converter in the hardware architecture such that the power equilibrium and communication among these converters can be established and that the system will be ready to receive any power demand. The voltage droop channel rotation scheme can implement the rotation of the DC/DC converters which are responsible for supporting the DC bus voltage on a regular basis during normal operation such that responsibilities are evenly distributed among all batteries. The SOC balancing scheme can be employed to align the SOC of selected SL batteries.

With the PCS according to aspects of this disclosure, the independent on-demand power control to both the grid-connected AC terminal and each SL battery can be realized. With this PCS, the reliability of continuous operation of the BESS can be increased, and each battery within the BESS can be well managed to increase their serviceable life span.

Another aspect of this disclosure is a power control system for controlling a battery energy storage system (BESS) which uses second-life (SL) electric vehicle (EV) batteries as energy storage units, the system comprising: a hardware architecture including: an AC/DC converter in which an AC side of the AC/DC converter is connected to an electrical grid via a first terminal and a DC side of the AC/DC converter is connected to a DC bus, and a plurality of DC/DC converters, a primary side of each of the DC/DC converters is connected to the DC bus and a second side of each of the DC/DC converters is connected to one of the EV batteries via a corresponding battery terminal; and a controller configured to coordinate the AC/DC converter and the DC/DC converters to maintain power equilibrium.

In some embodiments, the control circuit is further configured to independently control current, power, and energy at the first terminal of the AC/DC converter and at each of the battery terminals of the DC/DC converters.

In some embodiments, the control circuit is further configured to implement utility side peak-shaving energy management and pack-level battery energy management.

In some embodiments, each of the DC/DC converters is connected to a single one of the EV batteries that is not connected to any other one of the DC/DC converters.

In some embodiments, two of the DC/DC converters are connected to one of the EV batteries.

In some embodiments, each of the DC/DC converters is only connected to a single one of the EV batteries.

In some embodiments, each of the DC/DC converters comprises a plurality of independent channels, and each of the channels is connected to one of the EV batteries.

In some embodiments, each of the DC/DC converters comprises a plurality of independent channels, and of the EV batteries is connected to two or more of the channels.

In some embodiments, each of the DC/DC converter comprises two resonant type converters arranged in opposing directions.

In some embodiments, each of the DC/DC converter comprises a dual-active-bridge (DAB) type of converter.

In some embodiments, the control circuit is configured to control each of the DC/DC converters to exhibit current source characteristics in order to realize on-demand power and/or current control.

In some embodiments, the control circuit is configured to control each of the DC/DC converters to be commuted in a zero-voltage-switching (ZVS) operation region.

In some embodiments, each of the DC/DC converters supports native voltage droop control mode.

In some embodiments, the controller is configured to implement one or more of the following functionalities: normal operation control, exception and fault handling, data logging, start-up control, a voltage droop channel rotation scheme, and a state-of-charge (SOC) balancing scheme.

In some embodiments, the controller is configured to execute start-up control including: sending out a specific sequence of commands to the AC/DC converter and each of the DC/DC converters to establish the power equilibrium and communication among the AC/DC converter and each of the DC/DC converters such that the hardware architecture is ready to receive any power demand.

In some embodiments, the controller is configured to execute a voltage droop channel rotation scheme to rotate at least some of the DC/DC converters responsible for supporting a voltage on the DC bus on a regular basis during normal operation such that responsibilities are evenly distributed among the EV batteries.

In some embodiments, the controller is configured to execute a state-of-charge (SOC) balancing scheme to align a SOC of a selected set of the EV batteries.

In some embodiments, each of the DC/DC converters comprises a plurality of independent channels, the controller is configured to execute start-up control including, in response to only one of the channels being available: starting up the AC/DC converter in active-front-end (AFE) mode, establishing a stable DC bus voltage, and starting up the available channel in power/current control mode, or starting the available channel in voltage droop mode, putting the DC channel into standby, and starting the AC/DC converter in inverter mode.

In some embodiments, each of the DC/DC converters comprises a plurality of independent channels, the controller is configured to execute start-up control including, in response to two of the channels being available: starting up the AC/DC converter in active-front-end (AFE) mode, establishing a stable DC bus voltage, and starting up the available channels in power/current control mode, or starting one of the available channels in forward voltage droop mode and putting the other available channel in standby, staring up the AC/DC converter in inverter mode and sending a modest forward power command, waiting for the power equilibrium to establish and stabilize, and then starting up the other available channel in reverse voltage droop mode.

In some embodiments, each of the DC/DC converters comprises a plurality of independent channels, the controller is configured to execute start-up control including, in response to three or more of the channels being available: starting a first one of the available channels in forward voltage droop mode and putting the first channel in standby, staring up the AC/DC converter in inverter mode sending a modest forward power command, and waiting for the power equilibrium to establish and stabilize, starting up a second one of the available channels in reverse voltage droop mode, and starting the remaining available channels in ordinary power/current control mode.

In some embodiments, each of the DC/DC converters comprises a plurality of independent channels, the controller is configured to execute a voltage control channel rotation scheme comprising: identify a number of batteries with one channel available and a number of batteries with at least two channels available, create a first rotation combination including the channels corresponding to the batteries with one channel available, create a second rotation combination including the channels corresponding to the batteries with at least two channels available, form a final combination including the first and second rotation combinations, and regularly select a new channel to be applied with a voltage droop mode based on the final combination using a defined rotation time.

In some embodiments, each of the DC/DC converters comprises a plurality of independent channels, the controller is configured to execute a state-of-charge (SOC) balancing scheme comprising: acquire a SOC for each of the EV batteries, employ a power interpreter to translate differences in the SOCs of the EV batteries to respective power command coefficients, adjust the power command coefficients according to calculated voltage converging trajectories, and send the adjusted power command coefficients to the channels corresponding to the EV batteries as final power commands.

### BRIEF DESCRIPTION OF THE DRAWINGS

FIG. 1 illustrates a system architecture and its application context according to aspects of this disclosure.

FIG. 2A illustrates a first embodiment of the system architecture of FIG. 1.

FIG. 2B illustrates a second embodiment of the system architecture of FIG. 1.

FIG. 3A illustrates a first topology for the DC/DC converters of FIGS. 2A and 2B having a resonant type.

FIG. 3B illustrates a second topology for the DC/DC converters of FIGS. 2A and 2B having a dual-active-bridge (DAB) type.

FIG. 4 is an overall flowchart of the system control procedures according to aspects of this disclosure.

FIG. 5 is a main-sequence flowchart of the system operation according to aspects of this disclosure.

FIG. 6A is an illustration of an embodiment of a control strategy being implemented with independent power control of the AC/DC converter and the DC/DC converter No. 2 and No. 3.

FIG. 6B is an illustration of an embodiment of a control strategy being implemented with independent power control of the AC/DC converter and the DC/DC converter No. 1 and No. 4.

FIG. 7A is an illustration of an embodiment of a strategy for power equilibrium channel rotation for the sequences for two example cases.

FIG. 7B is an illustration of an embodiment of a strategy for power equilibrium channel rotation for an implementation of example case No. 2.

FIG. 8A is an illustration of an embodiment of a strategy for pack level SOC balancing shown as an overall flowchart.

FIG. 8B is an illustration of an embodiment of a strategy for pack level SOC balancing with case examples for three packs, procedures, and results.

### DETAILED DESCRIPTION

This disclosure relates to a power control system (PCS) for a grid-connected battery energy storage system (BESS) which uses second life (SL) electric vehicle (EV) battery packs as storage units. In particular, the PCS involves a hardware architecture and a corresponding control strategy. The hardware architecture features one grid-tied AC/DC converter, which may work in either inverter mode or active-front-end (AFE) mode, and multiple bi-directional DC/DC converters. The AC end of the AC/DC converter has interconnection with the utility grid. The DC end of the AC/DC converter and the primary sides of all DC/DC converters are interconnected to a common DC bus. The secondary sides of the DC/DC converters are connected to respective second-life EV battery packs. The corresponding control strategy can be implemented on a controller or other control circuit such as a computer or an embedded control unit. The control strategy coordinates all the converters to maintain power equilibrium such that the current/power/energy can be independently controlled both at grid-tied AC terminal and at each battery terminal, facilitating both utility side peak-shaving energy management and pack-level battery energy management. A state-of-charge (SOC) balancing strategy is also involved and can be implemented along with the main control strategy to align the SOC of selected EV battery packs.

### Introduction to Using SL EV Battery Packs as the Storage Units in BESSs

Power generation utilizing renewable energy sources has been playing an ever-increasing role globally both to meet the growing demand and to mitigate the climate change caused by carbon emission. The most popular renewable energy sources such as solar energy and wind energy suffer from intrinsic unpredictability and fluctuation, resulting in the same weaknesses in their respective power generation. Adding a battery energy storage system (BESS) to these systems greatly improves the overall output quality and brings benefits to both users and the utility grid. To realize these capabilities, the BESS should be grid-tied and capable of deliver or absorb power on user demand.

With the advancement in lithium technologies and the resulting decreased costs, the popularity of BESS is in a continuous climb. One particular prospect is using SL EV battery packs as the storage units in BESSs. EVs to date already have a major share in the market and keep gaining momentum. A massive quantity of end-of-serviceable-life (EOL) batteries are projected to come out in the coming few years and thereafter. These retired EV batteries still have considerable capacities which qualify them to a SL usage in less demanding applications such as in stationary BESSs. This SL usage of EV batteries will generate considerable benefits regarding reducing material costs and environmental impact. Because the EOL EV batteries will have various capacities and state-of-health (SOH) depending on the make, model, and specific conditions of their respective EVs, a BESS using multiple such batteries should have the capability of individually controlling the power of each EV battery pack so that the aging of these batteries is delayed, and the overall cost reduced as a result.

Independent on-demand power control on both the grid-tied end and the battery end is challenging because it can be desirable to continuously maintain the power equilibrium and provide a high dynamic range to accommodate fluctuations in demand.

A BESS system with multiple storage units is featured in a number of designs. Relatively simple designs with direct parallel connection of battery modules can be found in patents such as U.S. Pat. No. 8,907,522 B2. Typically, a single DC/DC converter is used as the interface between all battery modules to the DC bus, therefore the independent control of each battery module is difficult to realize. Designs with each battery module connecting to the DC bus via its respective DC/DC converter provide more flexibility in battery control, but still with various constraints in the control freedom. In U.S. Pat. No. 6,043,629 A, multiple battery-converter units are coordinated by a central charge/discharge controller. The central controller relies on the real-time voltage sensing to regulate the DC bus voltage by actively distributing the load among all battery-converter units. The voltage feedback control requires high response speed and is difficult to achieve using ordinary inter-system communication protocols, resulting in the design overall atomic and difficult to scale by the user. In U.S. Pat. No. 8,245,801 B2, KR 10-1482300 B1, and US 2017/0358935 A1, multiple battery-converter units are also featured for electrified vehicle power system. In these designs, multiple battery-converter units can be independently controlled, but the bus voltage regulating relies on a higher priority storage-converter-controller module, meaning the units in these systems are not equal in importance.

A BESS with multiple storage units which are truly equal, easy to scale, supporting independent power control to all battery and AC terminals will provide great benefit in high-power and high-capacity SL EV BESS application but yet to be designed.

Aspects of this disclosure address the above-description problems by providing a PCS designed for BESSs which use SL EV batteries as energy storage units. The PCS includes a specific hardware architecture (or a specific group of similar architectures) and a corresponding control strategy.

In particular, aspects of this disclosure take into account the specific characteristics of second life EV battery packs as storage units which include: 1) different EV battery packs likely have different state of health due to different make, model, chemistry, and service age, thus requiring individual power control for longer remaining life, and 2) EV battery packs likely roll frequently and the whole storage system may scale, thus requiring any EV battery pack to be taken in or out without interrupt the system operation.

It is also desirable that the storage system as a whole can provide on demand power control and support local loads during outages. There are no existing systems that meet all the above aspects combined.

In summary, aspects of this disclosure provide technology that can realize a grid-connected battery energy storage system which uses second life EV batteries and has the capability of independent power and energy control of the grid connection interface and all storage units. This technology, together with various renewable energy generators such as solar PV and wind, delivers high performance in grid support applications including peak shaving and resilience enhancement. It also provides great potential in largely improving the utilization of EV batteries, leading to reduced cost and environmental impact.

### PCS System Architecture

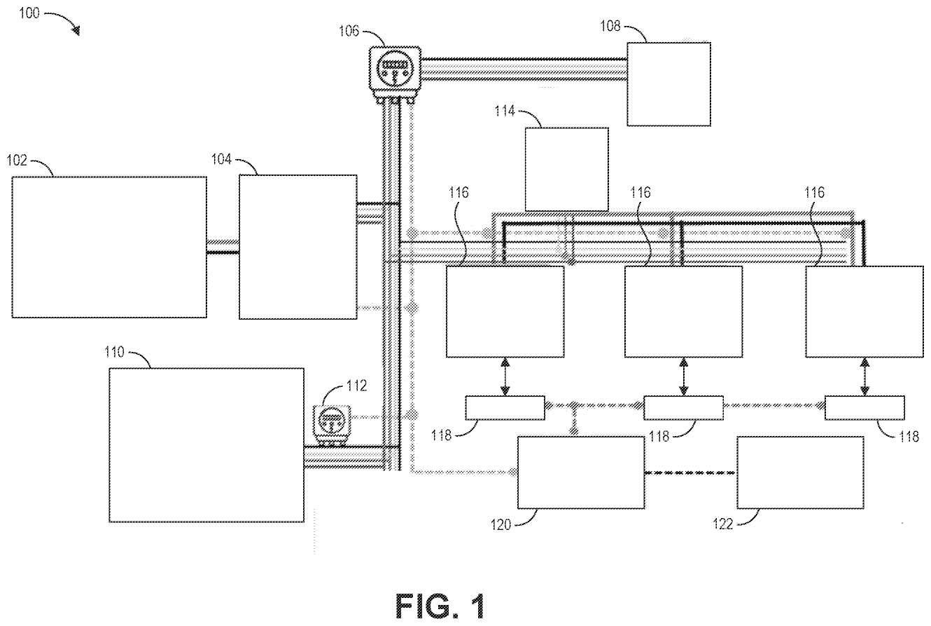

FIG. 1 is an overall illustration of the power control system (PCS) system architecture 100 and one typical context of the system's implementation. The PCS system architecture 100 includes a solar photovoltaic (PV) system 102, a solar inverter 104, a primary smart meter 106, a transformer 108, one or more building loads 110, a load meter 112, one or more battery inverters 114, a plurality of DC/DC converters 116, a plurality of battery management systems (BMSs) 118, a data hub 120, and a controller 122.

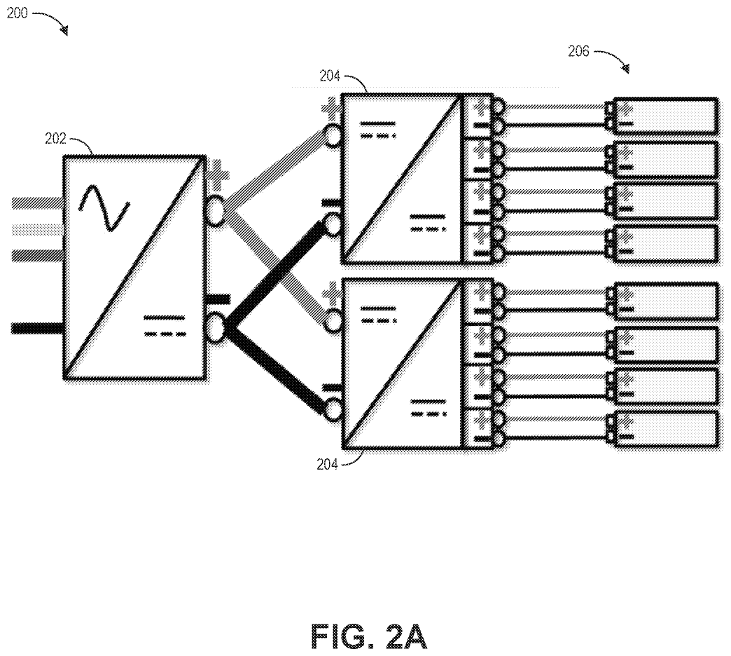

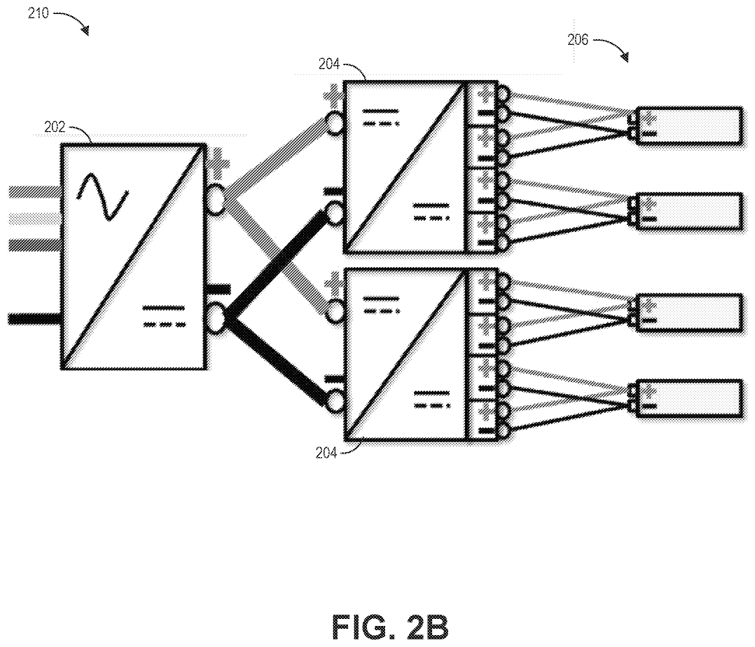

The left-hand side of FIG. 1 shows a utility user, such as a homeowner or a small/middle business owner, with the solar PV system 102. The PCS system architecture 100 is connected to the common utility mains via the transformer 108. The PCS system architecture 100 is also connected to the solar PV system 102 via the solar inverter 104 (e.g., an AC/DC converter). In some embodiments, each of the one or more battery inverters 114 can be implemented by an AC/DC converter, such as the AC/DC converters 202 illustrated in FIGS. 2A and 2B.

With reference to FIG. 1, one example application scenario for the PCS system architecture 100 of this disclosure is shown. For example, a utility user with an existing solar PV system 102 may desire a large enough grid-tied energy storage system to perform peak-shaving and to provide extra resiliency to the loads, so that the capacity of the solar PV system 102 can be fully utilized to save on utility bills. Additionally, the user may desire that during an outage the critical loads can maintain being fed by the storage system for long enough time until the utility recovers. Also, the user may desire for the storage units to be low cost and obtainable from various sources.

FIGS. 2A and 2B shows converters 200 and 210 including two possible embodiments of the DC/DC converters 116 for the PCS hardware architecture 100. In the embodiment of FIG. 2A, converter 200 the includes an active front end 202, a plurality of multichannel bi-directional DC/DC converters 204, and a plurality of battery packs 206 (e.g., second life EV battery packs). The active front end 202 can include an AC/DC converter to convert between the AC power used by the solar inverter 104, the one or more building loads 110, and/or the grid and the DC power used to store power within each of the battery packs 206.

In the embodiment of FIG. 2A, each channel of the independent DC/DC converters 204 is connected to its own one of the battery packs 206. As used herein and illustrated in FIGS. 2A and 2B, each independent DC/DC converter within a block of DC/DC converters 204 may be referred to as a “channel”. Moreover, a “channel” may be used to refer to an independent DC/DC converter throughout this disclosure.

The converter 210 of FIG. 2B is similar to the converter 200 other than the connections between the multichannel bi-directional DC/DC converters 204 and the battery packs 206. In particular, in the embodiment of FIG. 2B, each of the battery packs 206 is connected to two or more independent channels of the DC/DC converters 204.

Depending on the implementation, the number of independent DC/DC converters channels connected to the same battery pack 206 can be more than two. However, in other embodiments, each independent channel of a DC/DC converter 204 of the architecture is only connected to a single battery pack 206.

With reference to FIGS. 2A and 2B, the active front end 202 can include a single AC/DC converter and a plurality of independent DC/DC converters or channels of the DC/DC converters 204. The AC terminal of the AC/DC converter is connected to the utility grid via the transformer 108, the secondary side DC terminals of the DC/DC converters 204 are connected to their respective battery packs 206. The DC terminal of the AC/DC converter and the primary side DC terminals of the DC/DC converters can be interconnected via a common DC bus. The number of the independent channels and batteries is fully scalable such that in other similar embodiments of the architecture these numbers can be different without departing from aspects of this disclosure.

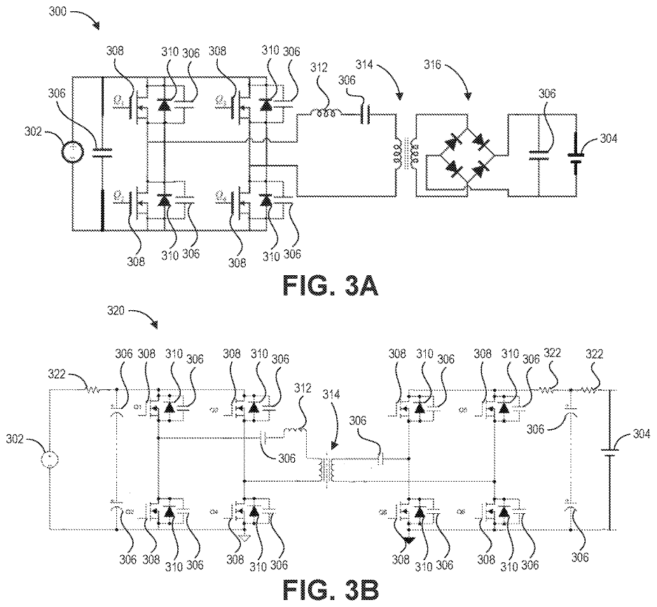

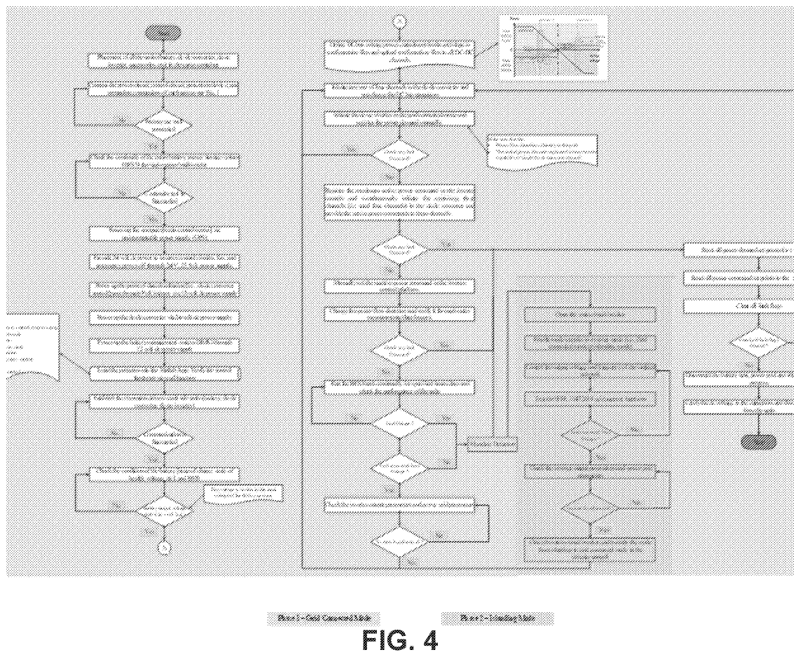

FIGS. 3A and 3B shows two example topologies of the DC/DC converters of FIGS. 2A and 2B. In particular, FIG. 3A shows a resonant type of converter (RC) 300. The converter 300 illustrated in FIG. 3A includes an input voltage 302, an output voltage 304, a plurality of capacitors 306, a plurality of transistors 308, a plurality of diodes 310, a plurality of inductors 312, a transformer 314, and a rectifier 316.

In FIG. 3A, the illustrated hardware circuit is capable of unidirectional power flow from the left-hand side to the right-hand side by controlling the circuit frequency (e.g., via the inputs Q1, Q2, Q3, and Q4 to the transistors 308). The left-hand side corresponds to the primary side of the DC/DC converter in the PCS while the right-hand side corresponds to the secondary side.

One implementation of the practical DC/DC converter has two identical sets of the circuit shown in FIG. 3A with one set in the direction illustrated in FIG. 3A and the other in the opposite direction. In this way, bi-directional power flow can be realized between the primary side and the secondary side—when power flow from the primary side to the secondary side is demanded, the circuit as illustrated in FIG. 3A is activated, while when power flow from the secondary side to the primary side is demanded, the circuit with the opposite direction as illustrated in FIG. 3A is activated.

FIG. 3B shows a dual-active-bridge (DAB) type of converter 320. The converter 320 of FIG. 3B is similar to the left-side portion of the converter 300 of FIG. 3A which is mirrored by the transformer 314 and also includes a plurality of resistors 322. This circuit 320 is intrinsically capable of bi-directional power flow by controlling the phase different between the primary side and the secondary side.

The characteristics of the converter 300 and 320 topologies illustrated in FIGS. 3A and 3B provide solid motivation for the application of the designed PCS system architecture 100. First, in order to realize on-demand power and/or current control, both circuits 300 and 320 can be controlled in such a way that they exhibit current source characteristics, which can make the direct voltage control challenging especially under high power conditions. Second, in order to achieve high power density and low loss at the same time, the switching devices (e.g., transistors 308) can be commuted in a zero-voltage-switching (ZVS) operation region. ZVS can be difficult to achieve during light load conditions, which makes the continuous change of direction of the power flow challenging considering that light load conditions may be inevitable near the zero-crossing region. As a result, most high-voltage and high-power DC/DC converters on the market perform well in current or power control mode, while fast power flow direction changes or direct voltage control (which may somewhat rely on the former) are either not available or available with very limited usage.

The use of either or both of the two DC/DC converter circuits 300 and 320 shown in FIGS. 3A and 3B gives the PCS system architecture 100 great generality in practical applications. As mentioned above, the direct voltage control and continuous changes of power flow direction can be difficult for these types of converters. One of the primary features of the disclosed PCS system architecture 100, therefore, is the particularly designed control strategy to startup and operate these converters such that the DC bus voltage control and independent power control can be achieved without putting particular requirements on the DC/DC converters 116 themselves. In order to implement the PCS system architecture 100, the DC/DC converters 116 are configured to support native voltage droop control mode, in which the power is linearly related to the DC bus voltage with fast dynamics (e.g., with a time constant of milliseconds or tens of milliseconds). This feature may be included in similar types of DC/DC converters on the market.

The PCS control strategy can be implemented in an embedded controller environment, or on any other type of computers which can provide sufficient processing power and reliability of uninterrupted operation. In certain embodiments of the PCS system architecture 100, the controller 122, the AC/DC converter 202, and each of the DC/DC converters 116 or 204 communicates using mainstream TCP/IP protocol (such as the MODBUS TCP protocol) via Ethernet cables within a shared local area network (LAN). A network device (such as a router) can be used in the LAN as the common connection junction. The controller 122 can send commands to and read data from various converters 116, 202, or 204 by sending network packages. The converters 116, 202, or 204 may not be required to directly talk to each other. In other embodiments, other communication interfaces and protocols can also be employed without departing from this disclosure.

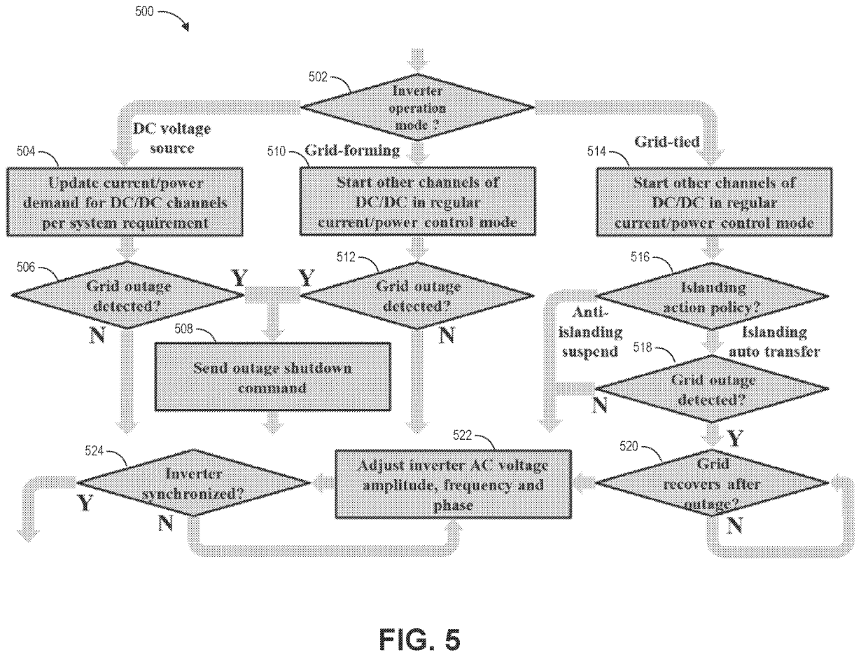

FIG. 4 is an embodiment of a master flowchart for operation for the PCS system architecture 100. The flowchart provides an example including the general startup, running, and stop procedures for the whole system. FIG. 5 provides additional details on the normal running state procedures 500 for the PCS system architecture 100.

In some embodiments, the PCS control strategy includes several distinct functionalities including one or more of the following: normal operation control, exception and fault handling, data logging, etc. Three desirable functionalities of the control strategy can include starting-up control, voltage droop channel rotation scheme, and SOC balancing scheme. These three functionalities may have corresponding instruction databases to identify different configurations of the DC channels and batteries and accordingly execute the matching sequences of commands.

The startup functionality can address at least three scenarios regarding the configuration of the DC channels and batteries. For the first scenario in which only one channel is available, there are two possible options: (a) starting up the AC/DC converter in AFE mode, establishing a stable DC bus voltage, and then starting up the DC channel in power/current control mode, or (b) starting the DC channel in voltage droop mode, putting the DC channel into standby, and then starting the AC/DC converter in inverter mode.

For the second scenario in which two channels are available, there are also two options including: (a) starting up the AC/DC converter in AFE mode, establishing a stable DC bus voltage, and then starting up both DC channels in power/current control mode, or (b) starting one of the DC channels in forward voltage droop mode and putting the DC channel in standby, next staring up the AC/DC converter in inverter mode and sending a modest forward power command, waiting for the power equilibrium to establish and stabilize, and then starting up the second DC channel in reverse voltage droop mode.

For the third and most typical scenario for the PCS system architecture 100 in which there are at least three channels available, the starting up procedure can include: 1) starting one of the DC channels in forward voltage droop mode and putting the DC channel in standby, 2) staring up the AC/DC converter in inverter mode and sending a modest forward power command, and then waiting for the power equilibrium to establish and stabilize, 3) starting up another DC channel in reverse voltage droop mode, and finally 4) starting the remaining channels in ordinary power/current control mode.

In the first and second scenarios, it may not be possible to achieve the anticipated benefit of independent power control. When the AC/DC converter is in AFE mode, the AC side on-demand power control may not be possible. When all the available DC channels are in voltage droop mode, the battery side on-demand power control may not be possible. However, the limited capability in these scenarios is determined by the lack of available channels and may not be improved by employing any other control strategy. The corresponding handling by the proposed control strategy can still provide a maximum possible or improved capability in system control.

Particularly in the third scenario, after the starting up procedures are completed, the independent power control on the AC side is ready thereafter. The independent power control of the battery side can also be achieved by specifically setting the power demand on the channel(s) which are in ordinary power/current control mode. It should be noted that, if all channel(s) connected to a certain battery are in voltage droop mode, then the on-demand power control for that battery may not be possible at the moment. However, because the disclosed control strategy has the voltage droop channel rotation functionality, the voltage control responsibility may not stay on that battery and can be shifted in turn. Therefore, the independent power control each battery is still achievable on a longer time scale.

FIG. 5 is a flowchart illustrating the normal running state procedures 500. With reference to FIG. 5, one or more blocks of the method 500 may be implemented, for example, by a processor of the PCS system architecture 100, such as the controller 122. With reference to FIG. 5, the normal running state procedures 500 starts at block 502 where the processor determines whether the AC/DC converter is in an inverter operation mode. When the AC/DC converter is in a DC voltage source mode, at block 504 the processor can update the current/power demand for the DC/DC channels per system parameters (or requirement). At block 506, the processor can determine whether a grid outage has been detected. When no grid outage is detected, the procedures 500 continue at block 524. When grid outage has been detected, the procedures 500 continue at block 508, where the processor sends an outage shutdown command. After sending the outage shutdown command, the procedures 500 continue at block 520.

Returning back to block 502, when the AC/DC converter is in a grid-forming mode, at block 510 the processor starts other channels of the DC/DC converter 204 in a regular current/power control mode. At block 512, the processor can determine whether a grid outage has been detected. When no grid outage is detected, the procedures 500 continue at block 522. When grid outage has been detected, the procedures 500 continue at block 508, described above.

Returning back to block 502, when the AC/DC converter is in a grid-tied mode, at block 514 the processor starts other channels of the DC/DC converter 204 in a regular current/power control mode. At block 516, the processor can determine whether to implement an islanding action policy. In response to determining not to implement the islanding action policy, the procedures 500 continue at block 522. In response to determining to implement the islanding action policy, the procedures 500 continue at block 518 where the processor can determine whether a grid outage has been detected. When no grid outage is detected, the procedures 500 continue at block 522. When grid outage has been detected, the procedures 500 continue at block 508, described above.

At block 520, the processor determines whether the grid has recovered after an outage. The procedures 500 remain at block 520 until the grid has recovered after an outage. After the grid has recovered, the procedures continue at block 522 where the processor adjusts the inverter AC voltage, amplitude, frequency, and/or phase. At block 524, the processor determines whether the inverter is synchronized. If the inverter is not yet synchronized, the procedures 500 return to block 522. Once the inverter has been synchronized, the procedures can return to block 502.

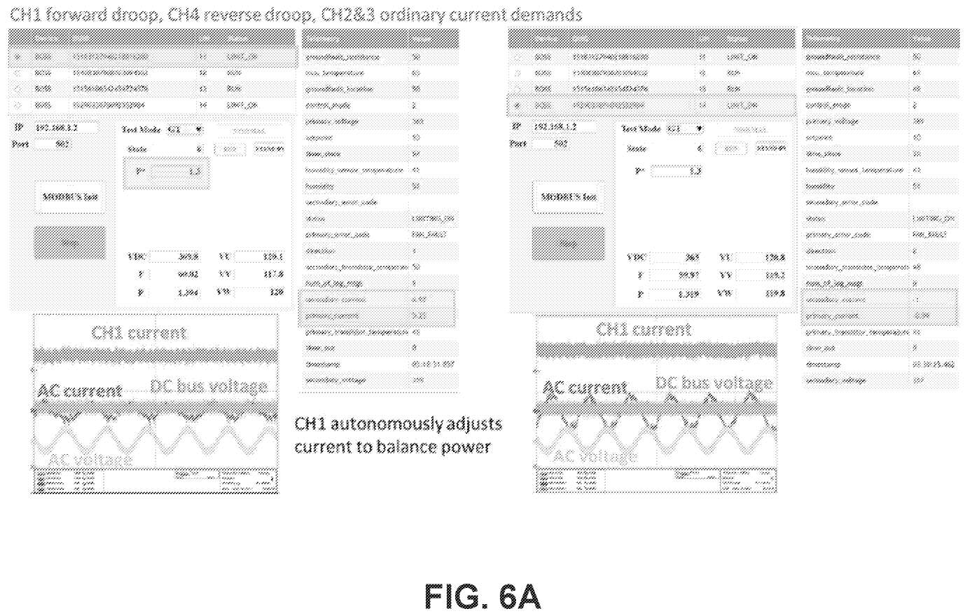

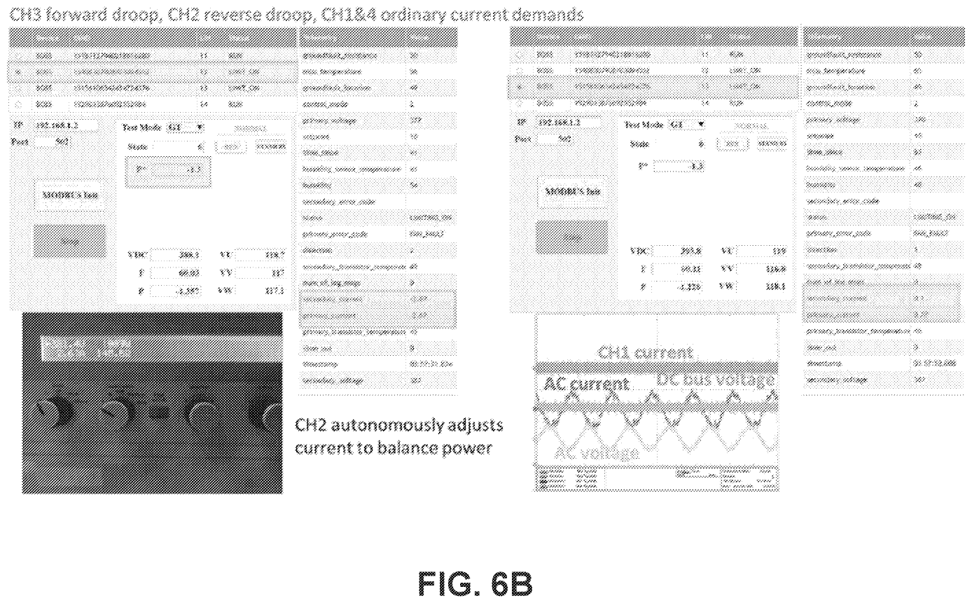

FIGS. 6A and 6B demonstrate two case examples of the PCS system architecture 100 in a normal running state. Four channels and two battery packs are used in these case examples. FIG. 6A shows Channel#1 and Channel#4 are responsible for DC bus voltage control while Channel#2 and Channel#3 are in ordinary power demand mode. FIG. 6B shows a scenario vice-versa. The on-demand power control to the AC/DC converter is also shown in FIGS. 6A and 6B. The independent power control on the AC side and on the battery side is evident in the independent set points for the AC/DC converter (P*) and the channels in power/current control mode (Primary current and Secondary current on the “RUN” channels).

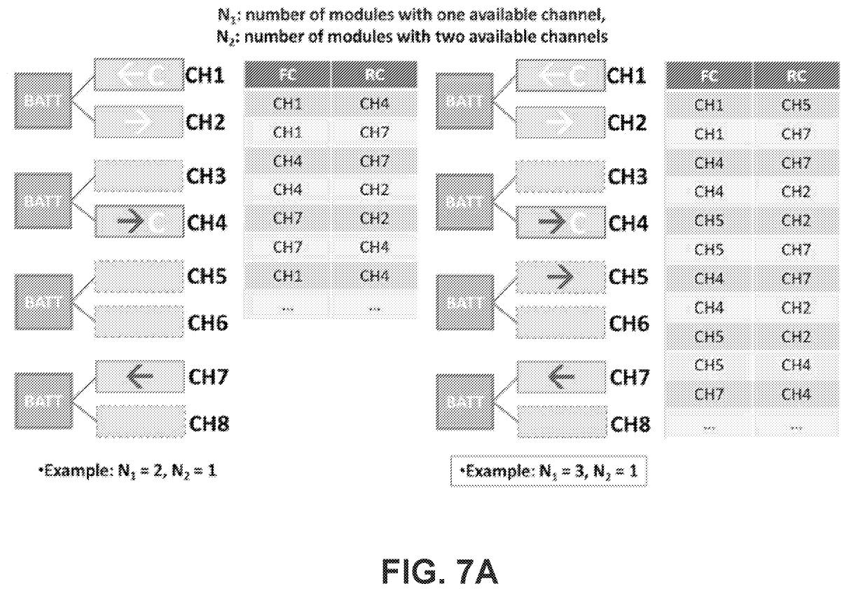

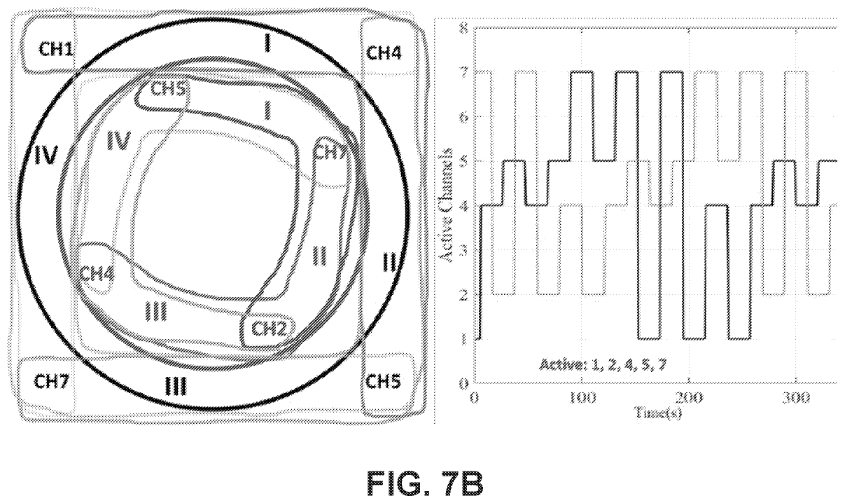

The voltage droop channel rotation scheme may concern the aforementioned third scenario in which at least three DC channels are available and the anticipated benefit of the proposed control strategy can be fully realized. The voltage droop channel rotation scheme includes two parts—the rotational voltage droop channel selection and channel shifting procedures. The channel selection method is illustrated in FIGS. 7A and 7B.

FIGS. 7A and 7B illustrate the principle and a case example of the voltage control channel rotation scheme. FIG. 7A provides the specific rotation sequence with two different channel availability scenarios. FIG. 7B shows an embodiment of the channel selection method and recorded channel rotation log for the second scenario in FIG. 7A.

In certain embodiments, the rotation involves first identifying the number of batteries with one channel available (N1) and the number of batteries with at least two channels available (N2), and then putting the channels in N1 and N2 in their respective rotation combinations, and to put the two combinations together to form a final combination. In this way, the voltage droop mode can be evenly distributed among all channels on a regular basis with the rotation time user definable. The channel shifting procedure depends on the voltage droop power range and is device specific. In a case example, the total secondary side current may correspond to the inverter power demand IF. Then the current demand can be set on CH3 to I3*, CH1 to I1*, CH2 to I2*, and CH4 to I4* (I2*, I4*<0), where IF>I3*+I2*+I4* and I1=IF−I3*−I2*−I4*<Imax and I1*>I1. In this way, the current of CH1 and CH3 can be distributed per demand. In this scenario CH1 is responsible for DC bus voltage control. To hand the DC bus voltage control over to CH3, set the current demand on CH3 to I3* and CH1 to I1*, where IF>I1* and I3=IF−I1*<Imax and I3*>I3. The shifting procedure is reflected in the change from FIG. 7A to FIG. 7B.

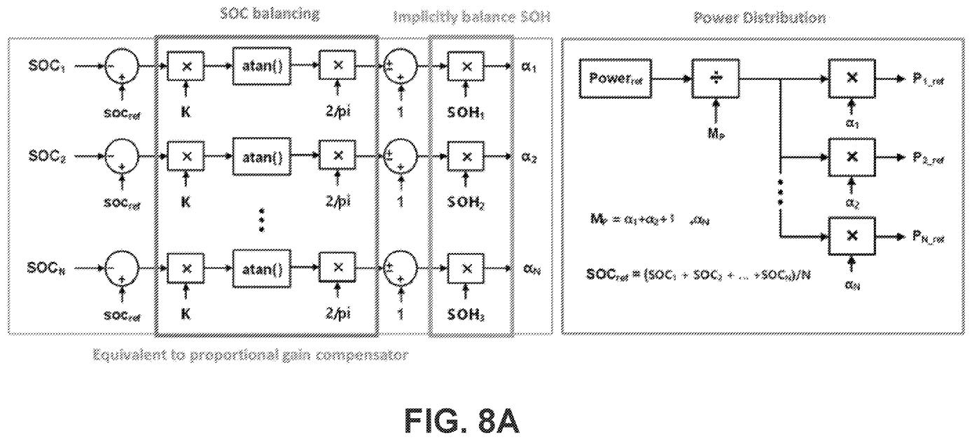

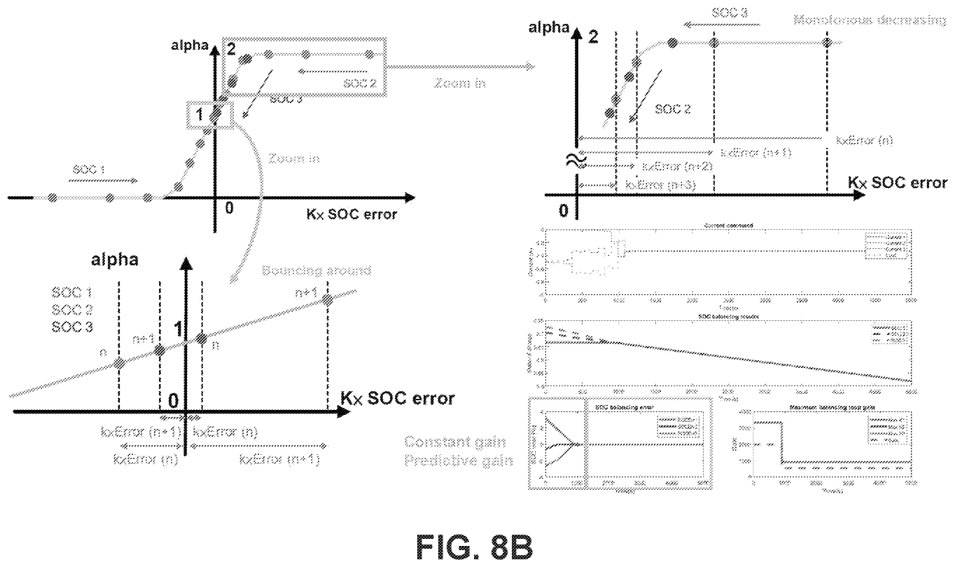

FIG. 8A provides a brief description for the SOC balancing procedures and FIG. 8B provides a case example of balancing three batteries. The SOC balancing scheme is a functionality that can be added to the independent power control capability of the PCS system architecture 100. The SOC balancing scheme can involve aligning the SOC of selected batteries, leveraging the independent power control capability. The SOC of the selected batteries SOC₁, SOC₂, and SOC₃ can be obtained using computational methods such as the Ampere-hour integration counter and various observer-based estimators. With acquired SOC SOC₁, SOC₂, and SOC₃ of the selected batteries, a power interpreter can be employed to translate the SOC differences to their respective power command coefficients α₁, α₂, and α₃,, as shown in FIG. 8A. Subsequently, the power demand coefficients α₁, α₂, and α₃ are further adjusted according to the calculated optimal voltage converging trajectories and finally send the corresponding channels for the batteries as final power commands P_{1_ref}, P_{2_ref}, and P_{3_ref}. This process is illustrated in FIG. 8B which features a case example of three batteries.

Methods described herein may be implemented as software and executed by a general purpose computer. For example, such a general purpose computer may include a control unit/controller or central processing unit (“CPU”), coupled with memory, EPROM, and control hardware. The CPU may be a programmable processor configured to control the operation of the computer and its components. For example, CPU may be a microcontroller (“MCU”), a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration. Such operations, for example, may be stored and/or executed by an onsite or remote memory.

While not specifically shown, the general computer may include additional hardware and software typical of computer systems (e.g., power, cooling, operating system) is desired. In other implementations, different configurations of a computer can be used (e.g., different bus or storage configurations or a multi-processor configuration). Some implementations include one or more computer programs executed by a programmable processor or computer. In general, each computer may include one or more processors, one or more data-storage components (e.g., volatile or non-volatile memory modules and persistent optical and magnetic storage devices, such as hard and floppy disk drives, CDROM drives, and magnetic tape drives), one or more input devices (e.g., mice and keyboards), and one or more output devices (e.g., display consoles and printers).

While the invention has been described in terms of several embodiments, those skilled in the art will recognize that the invention is not limited to the embodiments described, can be practiced with modification and alteration within the spirit and scope of the appended claims. In particular, the disclosure can be modified in terms of hardware and materials used to form the apparatus described herein. Any conventional or otherwise known materials could be implemented with the scope of the present disclosure. The description is thus to be regarded as illustrative instead of limiting.

1. A power control system for controlling a battery energy storage system (BESS) which uses second-life (SL) electric vehicle (EV) batteries as energy storage units, the system comprising:
a hardware architecture including:
an AC/DC converter in which an AC side of the AC/DC converter is connected to an electrical grid via a first terminal and a DC side of the AC/DC converter is connected to a DC bus, and
a plurality of DC/DC converters, a primary side of each of the DC/DC converters is connected to the DC bus and a second side of each of the DC/DC converters is connected to one of the EV batteries via a corresponding battery terminal; and
a controller configured to coordinate the AC/DC converter and the DC/DC converters to maintain power equilibrium.

2. The power control system of claim 1, wherein the controller is further configured to independently control current, power, and energy at the first terminal of the AC/DC converter and at each of the battery terminals of the DC/DC converters.

3. The power control system of claim 2, wherein the controller is further configured to implement utility side peak-shaving energy management and pack-level battery energy management.

4. The power control system of claim 1, wherein each of the DC/DC converters is connected to a single one of the EV batteries that is not connected to any other one of the DC/DC converters.

5. The power control system of claim 1, wherein two of the DC/DC converters are connected to one of the EV batteries.

6. The power control system of claim 1, wherein each of the DC/DC converters is only connected to a single one of the EV batteries.

7. The power control system of claim 1, wherein each of the DC/DC converters comprises a plurality of independent channels, and each of the channels is connected to one of the EV batteries.

8. The power control system of claim 1, wherein each of the DC/DC converters comprises a plurality of independent channels, and of the EV batteries is connected to two or more of the channels.

9. The power control system of claim 1, wherein each of the DC/DC converter comprises two resonant type converters arranged in opposing directions.

10. The power control system of claim 1, wherein each of the DC/DC converter comprises a dual-active-bridge (DAB) type of converter.

11. The power control system of claim 1, wherein the controller is configured to control each of the DC/DC converters to exhibit current source characteristics in order to realize on-demand power and/or current control.

12. The power control system of claim 1, wherein the controller is configured to control each of the DC/DC converters to be commuted in a zero-voltage-switching (ZVS) operation region.

13. The power control system of claim 1, wherein each of the DC/DC converters supports native voltage droop control mode.

14. The power control system of claim 1, wherein the controller is configured to implement one or more of the following functionalities: normal operation control, exception and fault handling, data logging, start-up control, a voltage droop channel rotation scheme, and a state-of-charge (SOC) balancing scheme.

15. The power control system of claim 1, wherein the controller is configured to execute start-up control including:
sending out a specific sequence of commands to the AC/DC converter and each of the DC/DC converters to establish the power equilibrium and communication among the AC/DC converter and each of the DC/DC converters such that the hardware architecture is ready to receive any power demand.

16. The power control system of claim 1, wherein the controller is configured to execute a voltage droop channel rotation scheme to rotate at least some of the DC/DC converters responsible for supporting a voltage on the DC bus on a regular basis during normal operation such that responsibilities are evenly distributed among the EV batteries.

17. The power control system of claim 1, wherein the controller is configured to execute a state-of-charge (SOC) balancing scheme to align a SOC of a selected set of the EV batteries.

18. The power control system of claim 1, wherein each of the DC/DC converters comprises a plurality of independent channels, the controller is configured to execute start-up control including, in response to only one of the channels being available:
starting up the AC/DC converter in active-front-end (AFE) mode, establishing a stable DC bus voltage, and starting up the available channel in power/current control mode, or
starting the available channel in voltage droop mode, putting the DC channel into standby, and starting the AC/DC converter in inverter mode.

19. The power control system of claim 1, wherein each of the DC/DC converters comprises a plurality of independent channels, the controller is configured to execute start-up control including, in response to two of the channels being available:
starting up the AC/DC converter in active-front-end (AFE) mode, establishing a stable DC bus voltage, and starting up the available channels in power/current control mode, or
starting one of the available channels in forward voltage droop mode and putting the other available channel in standby, staring up the AC/DC converter in inverter mode and sending a modest forward power command, waiting for the power equilibrium to establish and stabilize, and then starting up the other available channel in reverse voltage droop mode.

20. The power control system of claim 1, wherein each of the DC/DC converters comprises a plurality of independent channels, the controller is configured to execute start-up control including, in response to three or more of the channels being available:
starting a first one of the available channels in forward voltage droop mode and putting the first channel in standby, staring up the AC/DC converter in inverter mode sending a modest forward power command, and waiting for the power equilibrium to establish and stabilize, starting up a second one of the available channels in reverse voltage droop mode, and starting the remaining available channels in ordinary power/current control mode.

21. The power control system of claim 1, wherein each of the DC/DC converters comprises a plurality of independent channels, the controller is configured to execute a voltage control channel rotation scheme comprising:
identify a number of batteries with one channel available and a number of batteries with at least two channels available,
create a first rotation combination including the channels corresponding to the batteries with one channel available,
create a second rotation combination including the channels corresponding to the batteries with at least two channels available,
form a final combination including the first and second rotation combinations, and
regularly select a new channel to be applied with a voltage droop mode based on the final combination using a defined rotation time.

22. The power control system of claim 1, wherein each of the DC/DC converters comprises a plurality of independent channels, the controller is configured to execute a state-of-charge (SOC) balancing scheme comprising:
acquire a SOC for each of the EV batteries,
employ a power interpreter to translate differences in the SOCs of the EV batteries to respective power command coefficients,
adjust the power command coefficients according to calculated voltage converging trajectories, and
send the adjusted power command coefficients to the channels corresponding to the EV batteries as final power commands.
